(19) United States
(12) Patent Application Publication
(10) Pub. No.: US 2007/0074406 A1
(43) Pub. Date: Apr. 5, 2007

(54) POWER-OPERATED UNDER CUT SAW

(76) Inventor: Audrius Magyla, River Grove, IL (US)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 11/535,113

(22) Filed: Sep. 26, 2006

Related U.S. Application Data
(60) Provisional application No. 60/722,239, filed on Sep. 30, 2005.

(51) Int. Cl. B23D 49/00

(52) U.S. Cl. 30/392

(57) ABSTRACT

An undercut saw blade is removably connected to a reciprocating saw. The blade has a proximal end and a distal end. The blade is attached to a connector by two or more fasteners. The connector has a proximal end and a distal end. The distal end of the connector is adapted to be mounted on a reciprocating saw. The proximal end of the connector is mounted to the blade intermediate its proximal and distal ends by a first fastener. A second fastener attaches the blade to the connector intermediate the first fastener and the distal end of the blade. In a second embodiment, the undercut saw blade is removably connected to an offset member such that when the reciprocating saw moves axially, the offset saw blade moves axially in a plane parallel to the axial movement of the saw.

### CROSS REFERENCE TO RELATED APPLICATIONS

This application claims priority of U.S. Provisional Patent Application No. 60/722,239, filed Sep. 30, 2005.

### FIELD OF THE INVENTION

This invention pertains to a power-operated reciprocating saw, particularly, an undercut saw.

### BACKGROUND OF THE INVENTION

Reciprocating saws are often provided with removable blades, which provide a user with the opportunity to use different saws, blades, or other cutting edges depending on the requirements of the specific job. The blade-mounting systems of reciprocating saws allow users to easily change cutting edges needs to accommodate different cutting needs or to replace worn or damaged blades. However, the blade mounting systems typically only allow for the mounting of blades specifically manufactured for use with that specific type of reciprocating saw.

Typical undercut saws used by carpenters have not been mounted on reciprocating saws. Rather, the undercut saw has been operated manually, requiring a relatively long time for accomplishing cutting tasks using this saw.

The invention provides a means for using devices, such as undercut saws in conjunction with reciprocating saws.

### BRIEF DESCRIPTION OF THE DRAWINGS

FIG. 1 is a side view of a first embodiment of a saw blade with a connecting device for mounting the saw blade to a reciprocating saw;

FIG. 2 is a top view of the embodiment of Fig. 1;

FIG. 3 is a side view of the first embodiment of a saw blade with a connecting device for mounting the saw blade to a reciprocating saw using an alternative connecting assembly;

FIG. 4 is a top view of the embodiment of FIG. 3;

FIG. 5 is a side view of a second embodiment of a saw blade with a connecting device for mounting the saw blade to a reciprocating saw;

FIG. 6 is a top view of the embodiment of FIG. 5;

FIG. 7 is a side view of a second embodiment of a saw blade with a connecting device for mounting the saw blade to a reciprocating saw utilizing an alternative connecting assembly; and

FIG. 8 is a top view of the embodiment of FIG. 7.

### DETAILED DESCRIPTION OF THE INVENTION

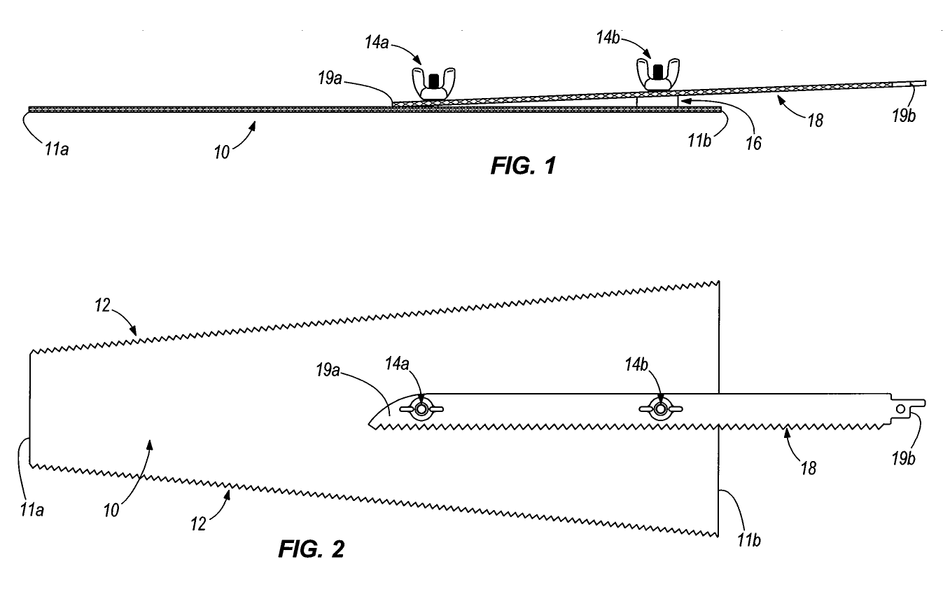

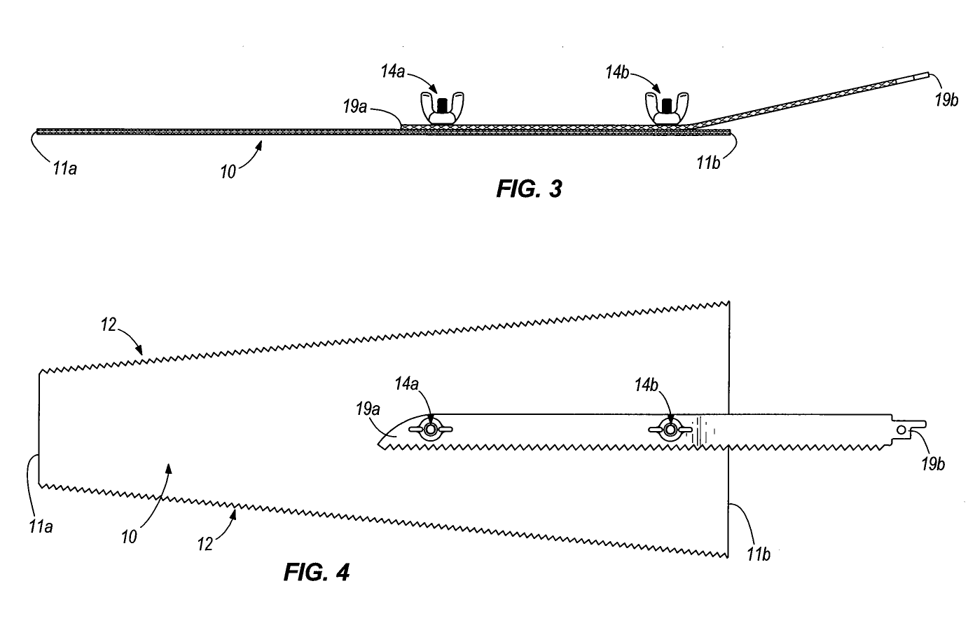

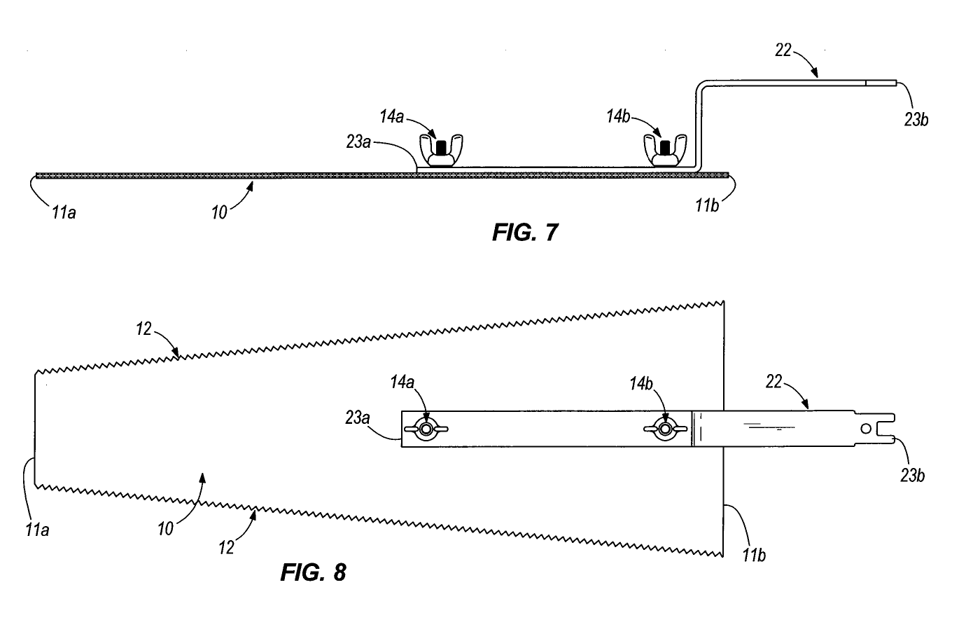

FIGS. 1 through 8 illustrate two embodiments of an assembly for connecting a cutting blade to a reciprocating saw or other power tool. In FIGS. 1 through 4, a saw blade 10 is shown mounted to a connector 18. In FIGS. 4 through 8, the saw blade 10 is shown mounted to an offset connector 22. The blade 10 has a proximal end 11a and a distal end 11b. In one embodiment of the invention, blade 10 is an undercut saw having teeth on both sides of the blade. However, any other suitable type of saw, blade, or other cutting edge may be used. As shown in the Figures, the blade 10 is attached to the connector 18 or offset member 22 by two or more fasteners 14. In one embodiment, the fastener 14 is a bolt and butterfly nut.

In FIGS. 1 through 4, the connector 18 has a proximal end 19a and a distal end 19b. The distal end 19b is adapted to be mounted a reciprocating saw (not shown), such as a Milwaukee® 10 amp SAWZALL® reciprocating saw. The proximal end 19a of the connector 18 is mounted to the blade 10 intermediate its proximal and distal ends 11a, 11b by a first fastener 14a. A second fastener 14b connects the blade 10 and the connector 18 intermediate the first fastener 14a and the distal end 11b of the blade 10. As shown in FIG. 1, a washer 16 is positioned between the blade 10 and a connector 18 in cooperation with the second fastener 14b. A washer 16 can also be positioned between the blade 10 and a connector 18 in cooperation with a first fastener 14a.

In the embodiment of FIGS. 1 through 4, the blade 10 is connected directly to a blade already mounted in the reciprocating saw.

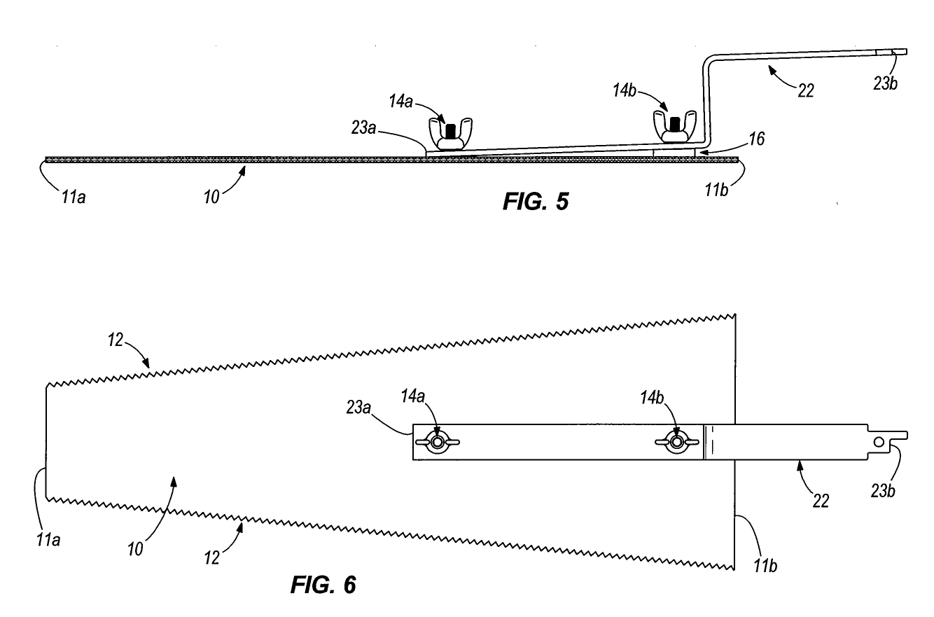

In FIGS. 5 through 8, the connector 22 is a handle or offset member. Offset member 22 has a proximal end 23a and a distal end 23b. Similar to the embodiment shown in FIGS. 1 through 4, the distal end 23b of the member 22 is adapted to be mounted for reciprocation within a reciprocating saw (not shown). The proximal end 23a of the offset member 22 is connected to the blade 10 intermediate its proximal and distal ends 11a, 11b by a first fastener 14a. A second fastener 14b connects the blade 10 and member 22 intermediate the first fastener 14a and the distal end 11b of the blade 10. In one embodiment, and as shown in FIG. 5, a washer 16 is positioned between the blade 10 and a connector 22 in cooperation with a second fastener 14b. A washer 16 can also be positioned between the blade 10 and offset member 22 in cooperation with a first fastener 14a. Between the second fastener 14b and the distal end 23b, the offset member 22 extends out and away from the blade 10. When the reciprocating saw moves axially, the offset saw blade moves axially in a plane parallel to the axial movement of the saw.

The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. Skilled artisans may employ such variations as appropriate, and the invention may be practiced otherwise than as specifically described herein. Accordingly, this invention includes all modifications and equivalents of the described subject matter, and any combination of the above-described elements, together with variations thereof, is encompassed by the invention unless otherwise indicated herein or otherwise clearly contradicted by context.

What is claimed is:

1. A saw blade adapted to be removably connected to a power-operated reciprocating saw, comprising:
a blade with teeth on both edges, the blade having two ends;
a connector having two ends;
wherein one end of the connector is mounted to the blade and the other end is mounted to the saw.

2. The saw blade of claim 1, wherein the saw blade is offset.

3. The saw blade of claim 2, wherein the reciprocating saw moves axially and the saw blade moves axially in a plane parallel to the axial movement of the saw.

4. A device for use in conjunction with a power tool, comprising:
an undercut saw blade;
fasteners;
wherein the fasteners removably connect the undercut saw blade to the power tool.

5. The device of claim 4, wherein the power tool is a reciprocating saw.

6. The device of claim 4, wherein the fasteners comprise bolts and butterfly nuts.

7. An assembly for removably connecting a cutting blade to a power tool comprising:
an undercut saw blade;
an offset member;
wherein the undercut saw blade is removably connected to the offset member; and
wherein the offset member is removably connected to the power tool.

8. The assembly of claim 7, wherein the power tool is a reciprocating saw.

9. The assembly of claim 8, wherein the reciprocating saw moves axially and the saw blade moves axially in a plane parallel to the axial movement of the saw.

10. The assembly of claim 9, wherein the undercut saw blade and the offset member each have proximal and distal ends, and the assembly includes a plurality of fasteners for removably attaching the saw blade to the offset member, wherein the distal end of the connector is adapted to be mounted on a reciprocating saw and the proximal end of the connector is mounted on the blade intermediate its proximal and distal ends.
